(19) United States
(12) Patent Application Publication
(10) Pub. No.: US 2026/0301448 A1
(43) Pub. Date: Oct. 1, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventor: KENTARO DOBA, TOKYO (JP)

(21) Appl. No.: 19/480,302

(22) PCT Filed: May 9, 2024
(86) PCT No.: PCT/JP2024/017252

§ 371 Date: Oct. 30, 2025

(30) Foreign Application Priority Data
May 19, 2023 (JP) 2023-082713

(51) Int. Cl. G06V 20/70; G01S 7/481; G01S 7/4865; G01S 17/89; G06V 10/26; G06V 20/58

(52) U.S. Cl. CPC G06V 20/70; G01S 7/4816; G01S 7/4865; G01S 17/89; G06V 10/26; G06V 20/58

(57) ABSTRACT

An information processing device includes: an environment determination unit that determines a state of an environment; a recognition processing unit that performs recognition processing on the basis of a detection result of a sensor; and a communication unit that performs communication processing with an external device, in which in a case where the environment is in a first state, the recognition processing unit performs recognition processing on the basis of the detection result of the sensor, and the communication unit transmits the detection result of the sensor and the recognition result of the recognition processing unit to the external device.

### TECHNICAL FIELD

The present technology relates to an information processing device, an information processing method, and a program.

### BACKGROUND ART

Currently, there is a technology for executing recognition processing such as semantic segmentation on the basis of a detection result of light detection and ranging (LiDAR) in order to, for example, improve the accuracy of automated driving and driving support of an automobile. LiDAR is a sensing technology capable of detecting a distance to a target and a property of the target. In recent years, in addition to sensors such as in-vehicle cameras and millimeter wave radars, the importance of LiDAR that can detect the position and shape of an object such as a vehicle and a pedestrian with high accuracy has increased.

Semantic segmentation is a technique of labeling each pixel constituting an image with information indicated by the pixel. The classification is performed according to which category the pixel belongs to, and labeling and category association of what is shown are performed. Information indicating what kind of subject a pixel constitutes can be attached to the pixel by semantic segmentation.

In order to improve the accuracy of recognition of the surrounding environment for automated driving and driving support of an automobile, a technique of selecting a plurality of recognition models for recognizing the surrounding environment on the basis of environmental data of the surrounding environment has been proposed (Patent Document 1).

### CITATION LIST

### Patent Document

Patent Document 1: Japanese Patent Application Laid-Open No. 2022-176816

### SUMMARY OF THE INVENTION

### Problems to be Solved by the Invention

However, in the technique of Patent Document 1, even if a recognition model is selected, sensing is performed in a bad environment where the accuracy of recognition and sensing is low, such as at night or in bad weather, and thus it can be said that it is insufficient in terms of improving the recognition accuracy in the bad environment.

The present technology has been made in view of such problems, and an object thereof is to provide an information processing device, an information processing method, and a program capable of performing recognition processing with high accuracy even in a bad environment.

### Solutions to Problems

In order to solve the above-described problem, a first technology is an information processing device including: an environment determination unit that determines a state of an environment; a recognition processing unit that performs recognition processing on the basis of a detection result of a sensor; and a communication unit that performs communication processing with an external device, in which in a case where the environment is in a first state, the recognition processing unit performs recognition processing on the basis of the detection result of the sensor, and the communication unit transmits the detection result of the sensor and the recognition result of the recognition processing unit to the external device.

Furthermore, a second technology is an information processing method including: determining a state of an environment; performing recognition processing on the basis of a detection result of a sensor; and performing communication processing with an external device, in which in a case where the environment is in a first state, the recognition processing is performed on the basis of the detection result of the sensor, and the detection result of the sensor and the recognition result of the recognition processing are transmitted to the external device.

Furthermore, a third technology is a program for causing a computer to execute an information processing method, the method including: determining a state of an environment; performing recognition processing on the basis of a detection result of a sensor; and performing communication processing with an external device, in which in a case where the environment is in a first state, the recognition processing is performed on the basis of the detection result of the sensor, and the detection result of the sensor and the recognition result of the recognition processing are transmitted to the external device.

Furthermore, a fourth technology is an information processing device including: a 3D map creation unit that creates a 3D map on the basis of a detection result and a recognition result of a sensor transmitted from an external device in a case where an environment is in a first state; a recognition information creation unit that creates information for recognition from the 3D map in a case where the environment is in a second state; and a communication unit that transmits the information for recognition to the external device.

Furthermore, a fifth technology is an information processing method including: generating a 3D map on the basis of a detection result and a recognition result of a sensor transmitted from an information processing device in a case where an environment is in a first state; creating information for recognition from the 3D map in a case where the environment is in a second state; and transmitting the information for recognition to the information processing device.

Moreover, a sixth technology is a program for causing a computer to execute an information processing method, the method including: generating a 3D map on the basis of a detection result and a recognition result of a sensor transmitted from an information processing device in a case where an environment is in a first state; creating information for recognition from the 3D map in a case where the environment is in a second state; and transmitting the information for recognition to the information processing device.

### BRIEF DESCRIPTION OF DRAWINGS

FIG. 1 is a block diagram illustrating a configuration of an information processing system 10.

FIG. 2 is an explanatory diagram of an outline of direct time of flight.

FIG. 3 is an explanatory diagram of an outline of direct time of flight.

FIG. 4 is an explanatory diagram of a SPAD.

FIG. 5 is an explanatory diagram of an output from a LiDAR 30.

FIG. 6 is an explanatory diagram of an output from the LiDAR 30.

FIG. 7 is an explanatory diagram of an output from the LiDAR 30.

FIG. 8 is a flowchart illustrating processing in an information processing device 100.

FIG. 9 is an explanatory diagram of processing in the information processing device 100.

FIG. 10 is a flowchart illustrating processing in a server 200.

FIG. 11 is an explanatory diagram of processing in the information processing device 100.

FIG. 12 is an explanatory diagram of processing in the server 200.

FIG. 13 is an explanatory diagram of a modification.

### MODE FOR CARRYING OUT THE INVENTION

Hereinafter, an embodiment of the present technology will be described with reference to the drawings. Note that the description will be made in the following order.
<Embodiment>
[Description of LiDAR 30 Using SPAD]
[Configuration of Information Processing Device 100]
[Configuration of Server 200]
[Processing in Information Processing System 10]
<Modification>

### Embodiment

### [Configuration of LiDAR 30 Using Information Processing System 10 and SPAD]

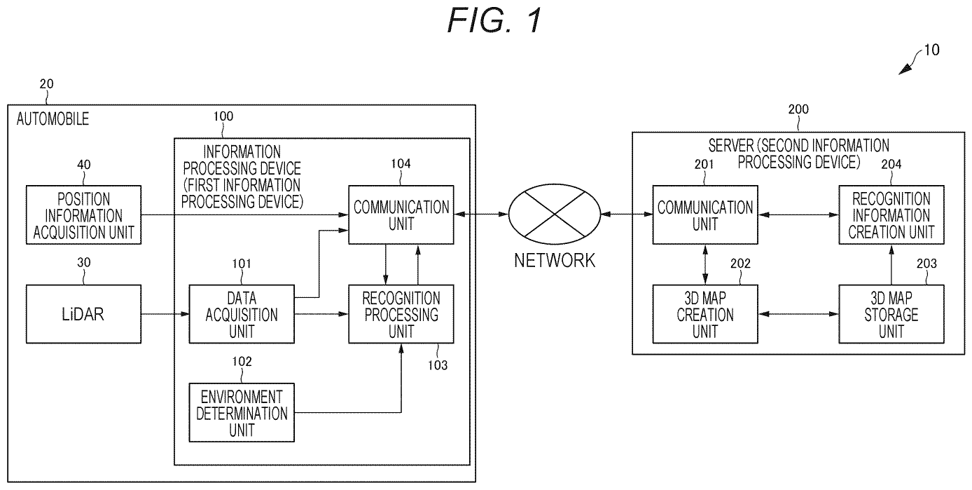

As illustrated in FIG. 1, an information processing system 10 includes an automobile 20, a LiDAR 30, a position information acquisition unit 40, an information processing device 100, and a server 200. The external device for the information processing device 100 is the server 200, and the external device for the server 200 is the information processing device 100.

The LiDAR 30 is connected to the information processing device 100. The LiDAR 30 may be connected to the information processing device 100 in a wired manner or in a wireless manner. Examples of the wired connection method include High-Definition Multimedia Interface (HDMI) (registered trademark) and Universal Serial Bus (USB), and examples of the wireless connection method include Wi-Fi, Bluetooth (registered trademark), and Near Field Communication (NFC).

In the present embodiment, the LiDAR 30 is provided as an in-vehicle sensor on the vehicle body of the automobile 20 as a moving body, and senses the surrounding environment of the automobile 20 such as the front of the automobile 20.

The LiDAR 30 measures scattered light with respect to irradiation of laser light emitting in a pulse shape, and detects a distance to a target object or substance, a property or a type of the object or the like.

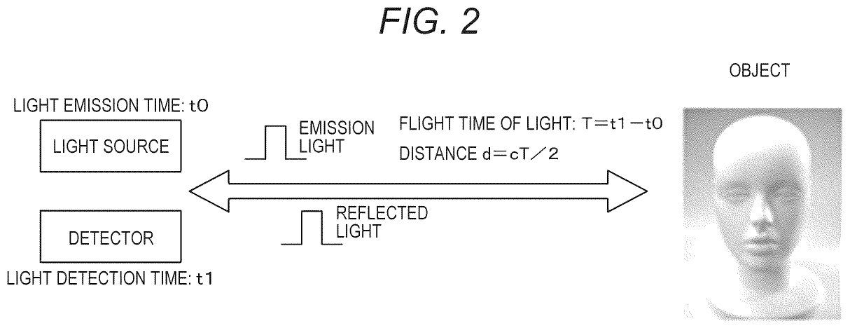

In the present embodiment, the LiDAR 30 measures a distance by a stacked direct time of flight (dToF) method using single photon avalanche diode (SPAD) pixels, which are single photon avalanche diodes. The SPAD pixel is used, among distance measuring methods of LiDAR, as a light receiving element of the dToF method for measuring a distance by detecting a flight time (time difference) of light that travels from a light source to an object, is reflected by the object, and returns as illustrated in FIG. 2 by a detector.

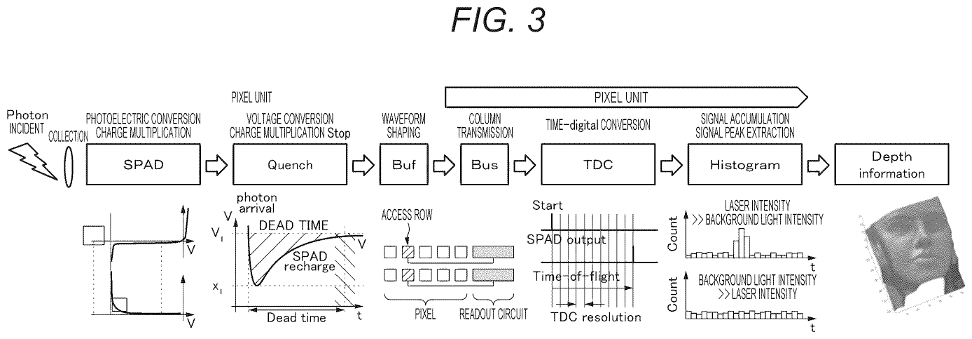

In the LiDAR 30 of the dToF method, as illustrated in FIG. 3, incident photons are collected and received by the SPAD to perform photoelectric conversion and charge multiplication. Next, voltage conversion is performed, charge multiplication is stopped, and waveform shaping is performed. Next, column transmission is performed, time-to-digital conversion is performed, and then a peak of the signal is extracted from the histogram, and a depth map is finally output.

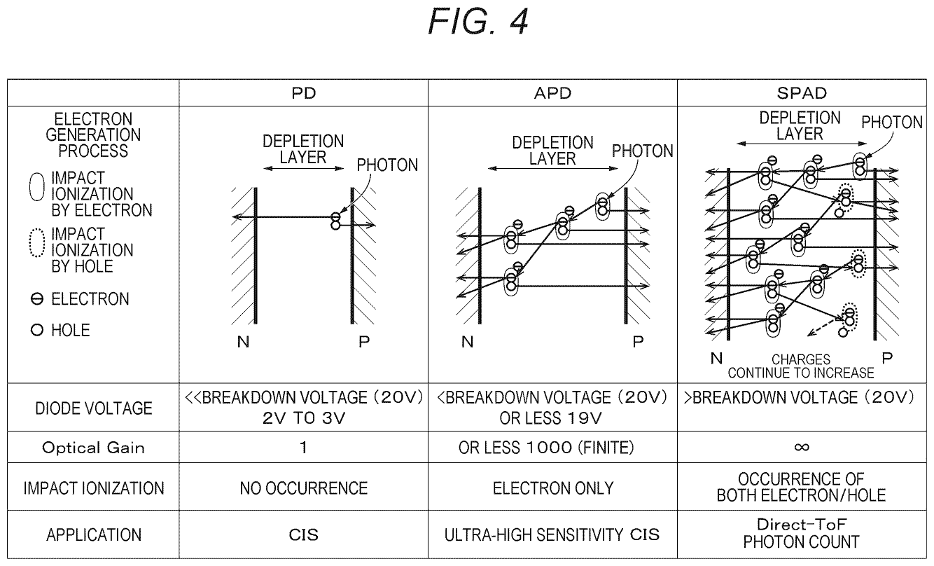

FIG. 4 illustrates an outline of the SPAD compared with a photo diode (PD) and an avalanche photo diode (APD). The SPAD is a device that is more sensitive than the PD and the APD, and can detect a single photon.

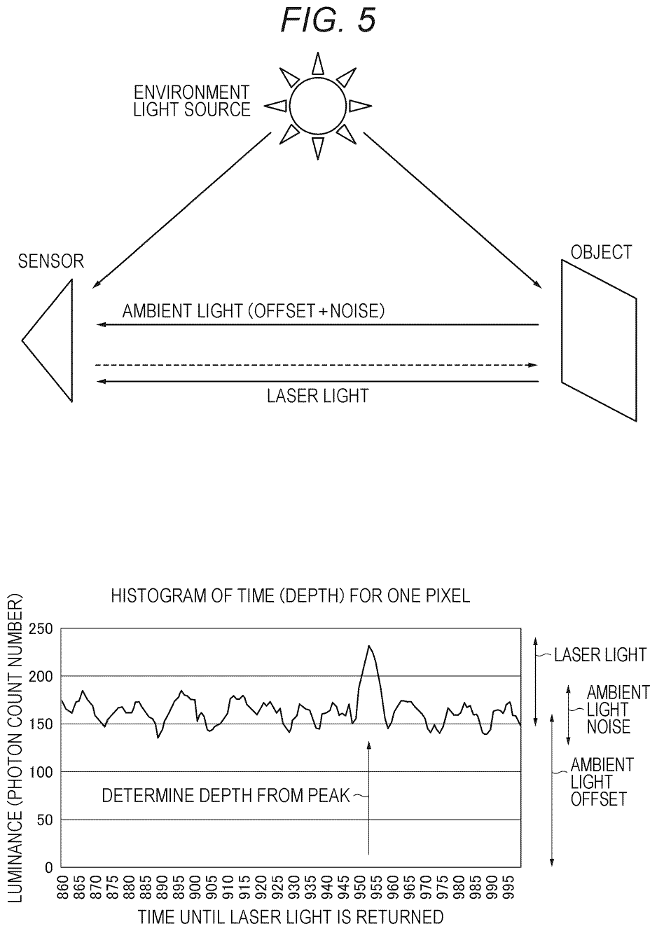

As illustrated in FIG. 5, in the LiDAR 30 using the SPAD pixels, depth (depth information) can be acquired as output data from a peak in the histogram of time until laser light for each pixel is returned and luminance (photon count number).

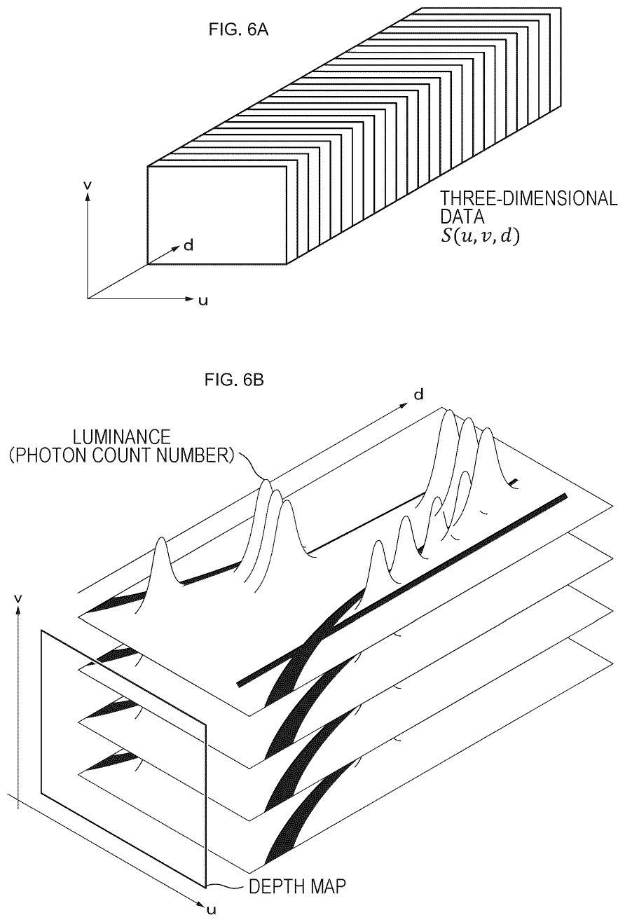

As illustrated in FIG. 6A, the structure of one frame of the output data of the LiDAR 30 is three-dimensional data represented by S(u, v, d). Furthermore, as illustrated in FIG. 6B, a depth D is expressed by the following Expression 1 using the three-dimensional data.

$$Depth D ( u , v ) = {arg max}_{d} S ( u , v , d ) \qquad [ Expression 1 ]$$

Furthermore, an intensity image (Intensity) that is output data of the LiDAR 30 can be converted into an ambient light image (Ambient).

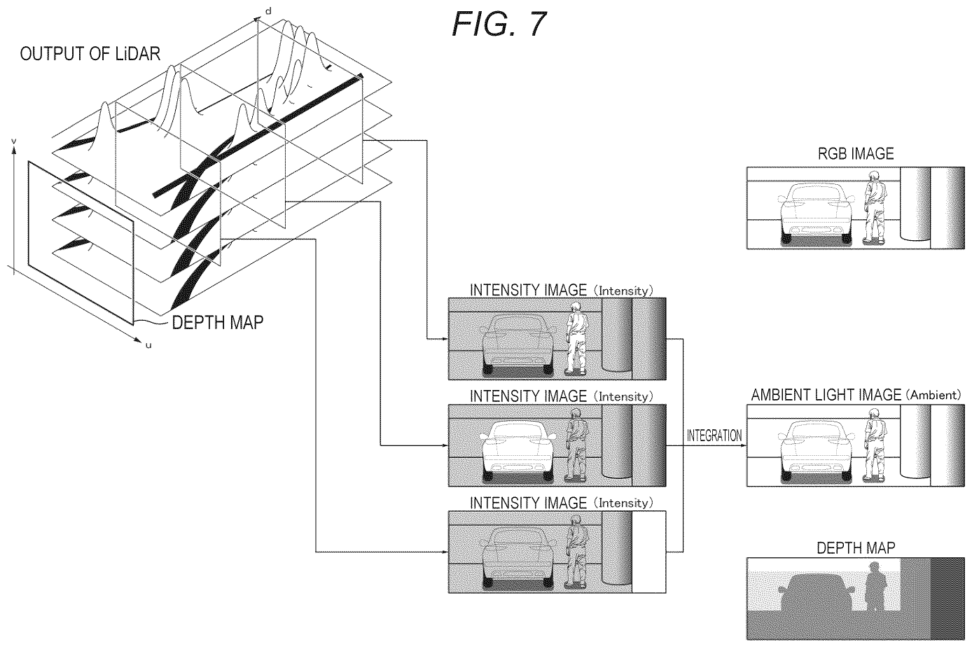

The conversion of the intensity image into the ambient light image can be performed by integrating a plurality of intensity images as output data of the LiDAR 30 as illustrated in FIG. 7. The ambient light image is obtained by integrating histograms for each pixel, and the intensity image can be converted into the ambient light image by integrating the plurality of intensity images in the output data of the LiDAR 30. The intensity image is an image constituted by peak values of a histogram for each pixel. In FIG. 7, for convenience of explanation, intensity images of a short distance, a middle distance, and a long distance included in the output data of the LiDAR 30 are extracted and illustrated. However, in actual integration, it is preferable to integrate all the intensity images included in the output data of the LiDAR 30.

The LiDAR 30 using the SPAD pixel can obtain distance information by the time until the infrared laser light emitted from the light emitting unit is received by the image sensor of the light receiving unit, and can also obtain the reflection intensity of the subject from the received light intensity of the infrared light in the light receiving unit. Furthermore, since the light receiving timing varies depending on the subject distance, the light receiving unit needs to be opened for a certain period of time, and as a side effect thereof, infrared ambient light can also be obtained. The distance information is obtained as a two-dimensional depth map, and the infrared reflected light and the infrared ambient light are obtained as a two-dimensional image. Hereinafter, a two-dimensional image of the infrared reflected light is referred to as an infrared reflected light image, and a two-dimensional image of the infrared ambient light is referred to as an infrared ambient light image. These pieces of information can be used as inputs of recognition processing such as semantic segmentation.

The position information acquisition unit 40 is a sensor such as a global positioning system (GPS) or a global navigation satellite system (GNSS) for acquiring the position of the automobile 20 having the function of the information processing device 100. The position information acquisition unit 40 is connected to the information processing device 100. The position information acquisition unit 40 supplies the acquired position information to a communication unit 104 of the information processing device 100. The position information acquisition unit 40 may be connected to the information processing device 100 in a wired manner or in a wireless manner. Examples of the wired connection method include HDMI (registered trademark) and USB, and examples of the wireless connection method include Wi-Fi, Bluetooth (registered trademark), and NFC. The position information acquisition unit 40 may be a function that the automobile 20 has in advance, or may be mounted on the automobile 20 as an apparatus separate from the automobile 20. The position information acquisition unit 40 acquires position information in synchronization with the LiDAR 30 by a predetermined synchronization signal or the like in order to detect the position of the automobile 20 at the time when the LiDAR 30 performs detection.

### [1-2. Configuration of Information Processing Device 100]

Next, a configuration of the information processing device 100 will be described with reference to FIG. 1. The information processing device 100 includes a data acquisition unit 101, an environment determination unit 102, a recognition processing unit 103, and the communication unit 104.

The data acquisition unit 101 acquires the detection result output from the LiDAR 30. As described above, the detection result of the LiDAR 30 is obtained as a depth map, an infrared reflected light image, and an infrared ambient light image. The data acquisition unit 101 converts the depth map into 3D point cloud information and supplies the 3D point cloud information to the communication unit 104. It is known in design that in which direction the LiDAR 30 using the SPAD pixel emits light entering each pixel due to the structure. By using the design data, the depth map can be converted into a 3D point cloud.

Furthermore, the data acquisition unit 101 supplies the infrared reflected light image and the infrared ambient light image to the recognition processing unit 103. Note that the conversion of the depth map into the 3D point cloud information may be executed by a dedicated processing unit, or the depth map may be transmitted to the server 200, and the depth map may be converted into the 3D point cloud information by the server. Note that the data acquisition unit 101 may also supply the depth map to the recognition processing unit 103 in addition to the infrared reflected light image and the infrared ambient light image. It is considered that accuracy can be improved by also using the depth map in semantic segmentation as recognition processing by the recognition processing unit 103.

The environment determination unit 102 determines whether the surrounding environment of the automobile 20 is a good environment or a bad environment. The good environment is a first state of the environment in the claims, and the bad environment is a second state of the environment in the claims.

The good environment is an environment that is bright, has good visibility, and can perform recognition processing in the recognition processing unit 103 with high accuracy on the basis of the detection result of the LiDAR 30. The good environment is, for example, a state in which the time zone is morning or daytime and the weather is sunny. Furthermore, the bad environment is an environment that is dark, has low visibility, and the detection result of the LiDAR 30 is also dark and the quality is poor, and as a result, the accuracy of recognition in the recognition processing unit 103 is reduced. The bad environment is, for example, a state in which the time zone is evening or nighttime, and the weather is a bad weather such as rain, snow, or fog. In the bad environment, since the visibility of the infrared ambient light as an input is reduced, it is expected that the performance of the recognition processing is also reduced.

The environment determination unit 102 determines whether the surrounding environment of the automobile 20 is the good environment or the bad environment on the basis of the illuminance. Furthermore, the environment determination unit 102 may determine whether the surrounding environment of the automobile 20 is the good environment or the bad environment on the basis of information regarding the weather such as a cloud amount and a precipitation amount in place of the illuminance or in combination with the illuminance.

Various sensors such as an illuminance sensor and a rainfall sensor may be mounted on the automobile 20, and the environment determination unit 102 may perform determination by acquiring sensing data from these sensors, or the environment determination unit 102 may perform determination by acquiring weather information from the Internet. The environment determination unit 102 supplies the determination result to the recognition processing unit 103.

For example, the environment determination unit 102 determines a state where the illuminance is 1000 1× or more, the cloud amount is 2 or less, and the precipitation amount is 0 mm as the good environment, and determines a state where any one of the conditions is not satisfied as the bad environment. Note that the types and values of the information such as the illuminance, the cloud amount, and the precipitation amount are merely examples, and the present technology is not limited to the types and values of the information. The information and the values used for determining the environment may be adjusted according to a country or an area, a season, a time, or the like. Moreover, the determination may be made using other information, for example, a snowfall amount.

The recognition processing unit 103 performs semantic segmentation as recognition processing using the infrared reflected light image and the infrared ambient light image obtained by the LiDAR 30 and supplied from the data acquisition unit 101. The recognition result of semantic segmentation is obtained as two-dimensional label data (hereinafter, may be referred to as a 2D label). Note that the recognition processing is not limited to semantic segmentation, and may be other recognition processing such as instance segmentation, object recognition, face recognition, moving object recognition, and scene recognition. The recognition processing unit 103 supplies the recognition result to the communication unit 104.

The recognition processing unit 103 switches between the processing in the case of the good environment and the processing in the case of the bad environment on the basis of the determination result of the environment determination unit 102. In the good environment, the recognition processing unit 103 performs recognition processing using the infrared ambient light image and the infrared ambient light image, which are detection results of the LiDAR 30. On the other hand, in the bad environment, the recognition processing unit 103 performs recognition processing using the 2D label as the information for recognition transmitted from the server 200.

The communication unit 104 transmits the recognition result of the recognition processing unit 103, the 3D point cloud information, and the position information to the server 200 via the network. Examples of the communication method include cellular communication, wireless local area network (LAN), wide area network (WAN), wireless fidelity (WiFi), fourth generation mobile communication system (4G), fifth generation mobile communication system (5G), and Ethernet (registered trademark). Note that the communication unit 104 may use a communication function provided in advance in the automobile 20, or may control a communication module separate from the automobile 20 to perform communication.

Note that, although not illustrated, the automobile 20 includes a control unit, an interface, and a storage unit.

The control unit includes a central processing unit (CPU), a random access memory (RAM), a read only memory (ROM), and the like. The ROM stores programs to be read and operated by the CPU, and the like. The RAM is used as a work memory of the CPU. The CPU controls the entire automobile 20 and each unit by executing various processes according to a program stored in the ROM and issuing commands.

The interface is a communication interface with an external device, the Internet, or the like. Examples of the communication method include wireless LAN, WAN, WiFi, 4G, 5G, and Bluetooth (registered trademark).

The storage unit is, for example, a mass storage medium such as a hard disk or a flash memory.

The information processing device 100 is configured as described above. In the present embodiment, the automobile 20 may have a function as the information processing device 100 in advance, a processor included in the automobile 20 may execute the function as the information processing device 100, or the automobile 20 having a function as a computer may execute a program to implement the information processing device 100 and the information processing method. The program may be installed in the automobile 20 in advance, or may be distributed by downloading, a storage medium, or the like and installed by a user or the like. Furthermore, the information processing device 100 may be configured as a single apparatus and mounted on the automobile 20.

### [Configuration of Server 200]

The server 200 includes a communication unit 201, a 3D map creation unit 202, a 3D map storage unit 203, and a recognition information creation unit 204.

The communication unit 201 receives the position information, the 3D point cloud information, and the recognition result transmitted from the information processing device 100 via the communication function included in the server 200, the communication module, and the network. Furthermore, the communication unit 201 transmits the 2D label to the information processing device 100 as the information for recognition created by the recognition information creation unit 204.

The 3D map creation unit 202 creates a 3D map to which a label is attached, the label being a result of semantic segmentation, on the basis of the 3D point cloud information, the position information, and the recognition result transmitted from the information processing device 100. Hereinafter, this 3D map is referred to as a labeled 3D map.

The 3D map storage unit 203 stores the labeled 3D map created by the 3D map creation unit 202. The 3D map storage unit 203 can be implemented by using a storage medium or the like normally included in the server 200.

The recognition information creation unit 204 creates a 2D label as information for recognition to be used for recognition processing of the information processing device 100 in the bad environment.

Note that, although not illustrated, the server 200 includes a control unit, an interface, and a storage unit. These configurations are similar to those included in the above-described automobile 20.

The server 200 is configured as described above. In the present embodiment, the server 200 operates as the second information processing device. A processor included in the server 200 may execute a function as the second information processing device, or the second information processing device and the information processing method thereof may be implemented by the server 200 executing the program. The program may be installed in the server 200 in advance, or may be distributed by downloading, a storage medium, or the like and installed by a user or the like.

### [1-2. Processing in Information Processing Device 100 and Server 200]

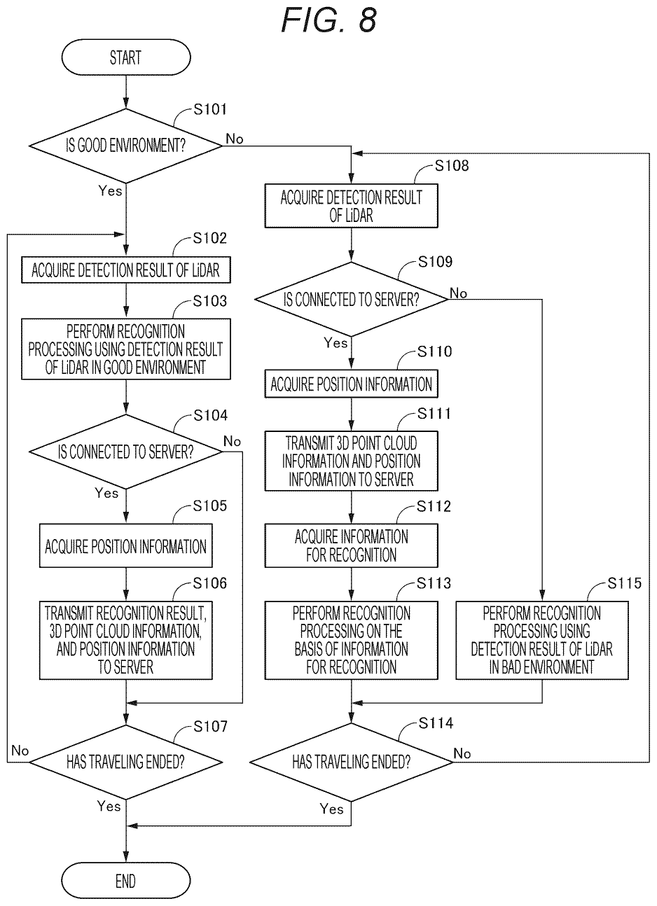

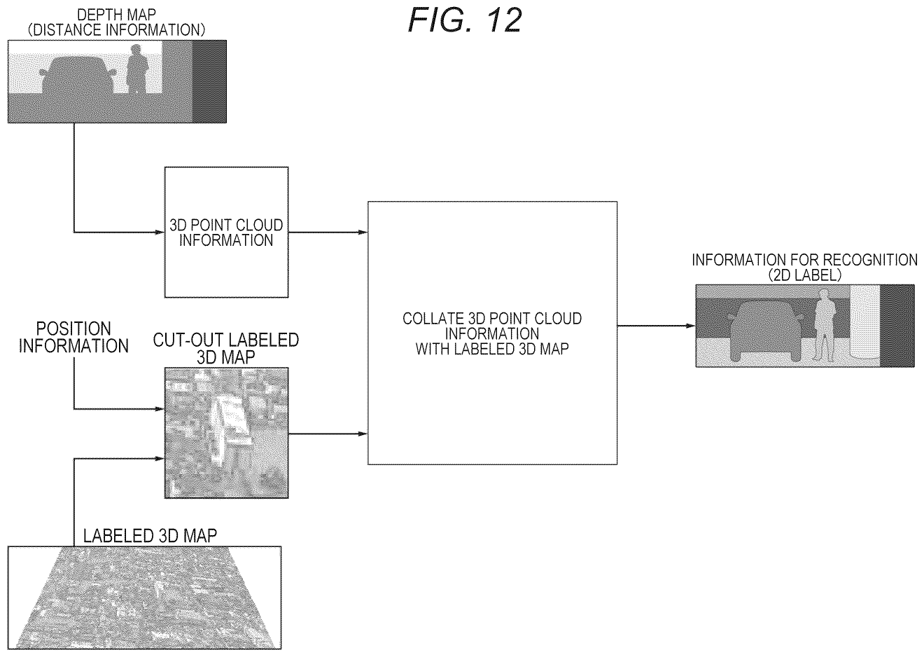

Next, processing in the information processing device 100 and the server 200 will be described with reference to FIGS. 8 to 12.

First, processing in the information processing device 100 will be described with reference to FIG. 8. In step S101, the environment determination unit 102 determines whether the surrounding environment of the automobile 20 is the good environment or the bad environment. In a case where the determination result is the good environment, the process proceeds to step S102 (Yes in step S101). On the other hand, in a case where the determination result is the bad environment, the process proceeds to step S108 (No in step S101). As described above, the information processing device 100 performs different processing depending on whether the surrounding environment of the automobile 20 is the good environment or the bad environment.

First, processing of the information processing device 100 in a case of the good environment will be described. In step S102, the data acquisition unit 101 acquires the depth map, the infrared reflected light image, and the infrared ambient light image, which are the detection results supplied from the LiDAR 30. The data acquisition unit 101 supplies the infrared reflected light image and the infrared ambient light image to the recognition processing unit 103. Furthermore, the data acquisition unit 101 converts the depth map into 3D point cloud information by performing polar coordinate conversion with a design value in a laser projection direction, and supplies the 3D point cloud information to the communication unit 104.

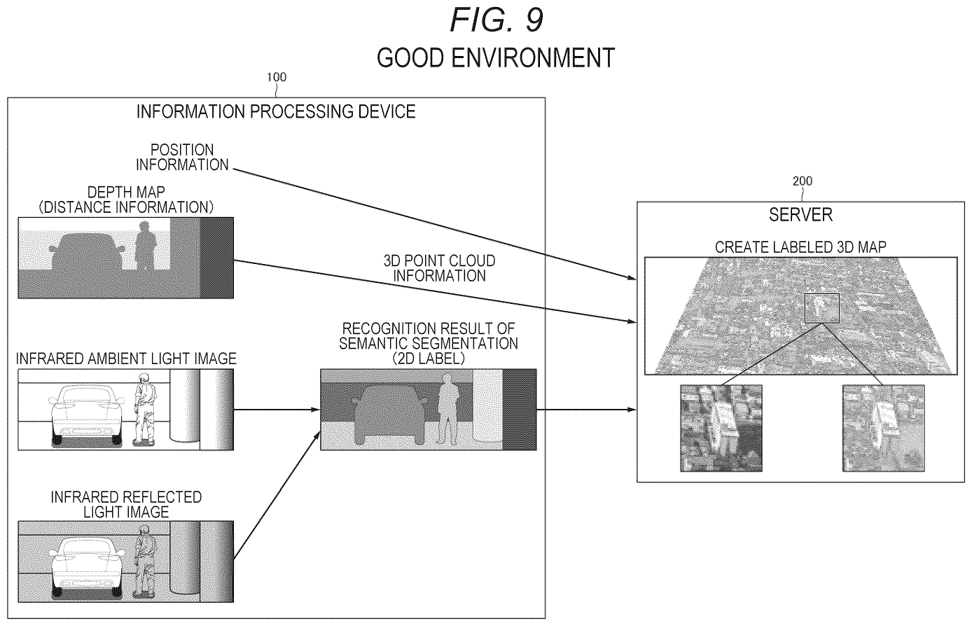

Next, in step S103, as illustrated in FIG. 9, the recognition processing unit 103 performs semantic segmentation as recognition processing using the infrared reflected light image and the infrared ambient light image. The recognition result of semantic segmentation is obtained as a 2D label. Regarding the recognition performance in the good environment, since it is expected that the performance can be sufficiently obtained by the existing method using the annotation, the recognition result of the semantic segmentation is transmitted to the server 200 as reference data.

Next, in step S104, in a case where the information processing device 100 is connected to the server 200, the process proceeds to step S105 (Yes in step S104).

Next, in step S105, the information processing device 100 acquires current position information of the automobile 20 from the position information acquisition unit 40. This position information is the position of the automobile 20 at the time when the LiDAR 30 performs detection.

Next, in step S106, the information processing device 100 transmits the recognition result, the 3D point cloud information, and the position information to the server 200 as illustrated in FIG. 9.

Then, in a case where the traveling of the automobile 20 has ended in step S107, the processing of the information processing device 100 ends (Yes in step S107). In a case where the traveling of the automobile 20 has not ended, the process proceeds to step S102 (No in step S107), and the information processing device 100 repeats steps S102 to S107 until the traveling of the automobile 20 ends.

As described above, the processing of the information processing device 100 in the good environment is performed.

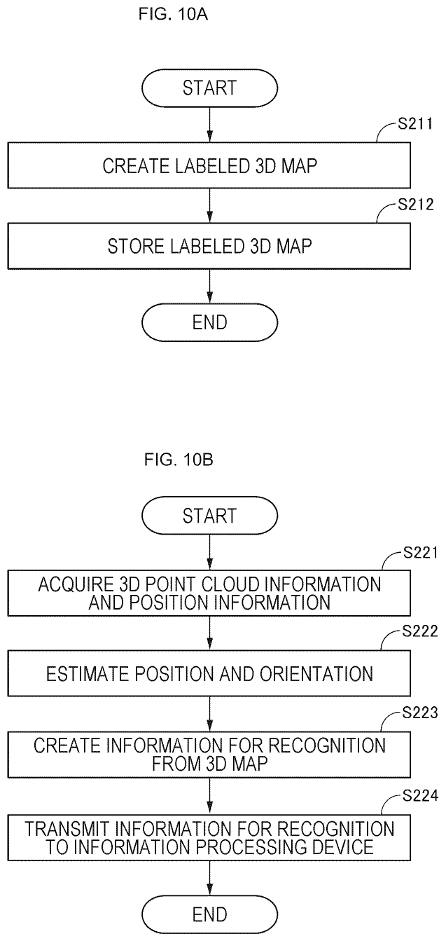

Next, processing of the server 200 in a case of the good environment will be described with reference to FIG. 10A. In step S211, the 3D map creation unit 202 creates a labeled 3D map by arranging and integrating the 3D point cloud information and the 2D label, which is the recognition result, on the basis of the position information as illustrated in FIG. 9. This labeled 3D map is a 3D map to which a label is attached, the label being the result of semantic segmentation. The 3D map creation unit 202 can create a large labeled 3D map by collecting and integrating a plurality of pieces of position information and 3D point cloud information acquired at various position angles in the good environment.

Next, in step S212, the 3D map storage unit 203 stores the labeled 3D map generated by the 3D map creation unit 202. In this manner, the server 200 creates the labeled 3D map on the basis of the information in the good environment, and stores the labeled 3D map so that the labeled 3D map can be used in the bad environment. The labeled 3D map created in the good environment has higher accuracy than the labeled 3D map that is created on the basis of the detection result of the LiDAR 30 with reduced quality in the bad environment.

Thus, the processing of the server 200 in the good environment is ended.

Next, processing of the information processing device 100 in a case of the bad environment will be described with reference to FIG. 8. In a case where the environment determination unit 102 determines in step S101 that the environment is not good, that is, in a case where the environment is bad, the processing proceeds to step S108 (No in step S101).

Next, in step S108, the data acquisition unit 101 acquires the depth map, the infrared reflected light image, and the infrared ambient light image, which are the detection results output from the LiDAR 30. The data acquisition unit 101 supplies the infrared reflected light image and the infrared ambient light image to the recognition processing unit 103. Furthermore, the data acquisition unit 101 converts the depth map into 3D point cloud information by performing polar coordinate conversion with a design value in a laser projection direction, and supplies the 3D point cloud information to the communication unit 104.

Next, in step S109, in a case where the information processing device 100 is connected to the server 200, the process proceeds to step S110 (Yes in step S109).

Next, in step S110, the information processing device 100 acquires current position information of the automobile 20 from the position information acquisition unit 40. This position information is the position of the automobile 20 at the time when the LiDAR 30 performs detection.

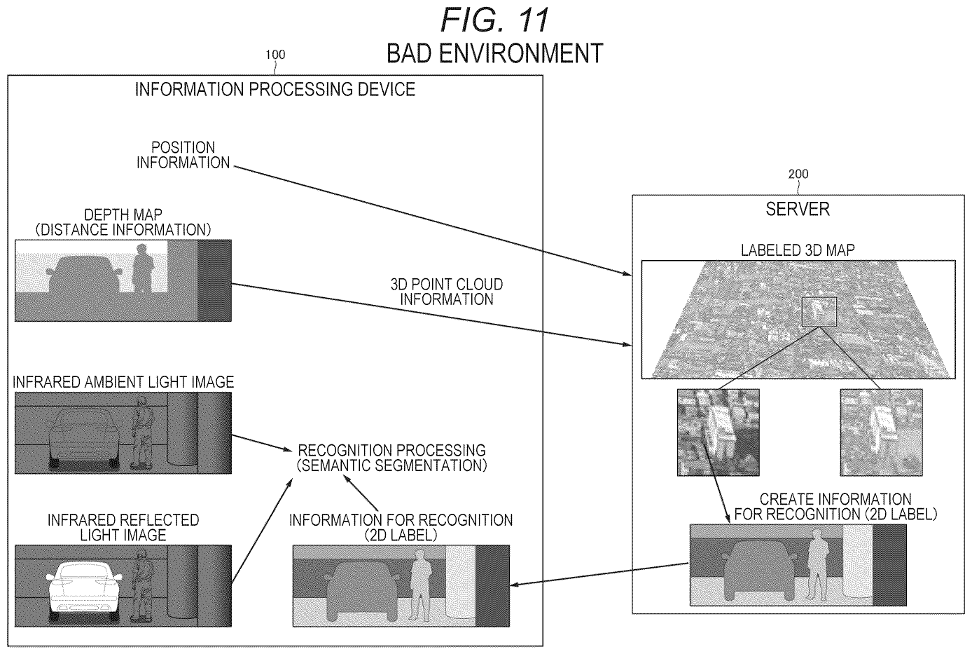

Next, in step S111, as illustrated in FIG. 11, the information processing device 100 transmits the 3D point cloud information and the position information to the server 200. When transmitting the 3D point cloud information and the position information, the information processing device 100 requests the server 200 to transmit the 2D label as the information for recognition generated by the server 200. The request data includes metadata (text data or the like) indicating whether the environment is good or bad. The server 200 refers to the metadata in the request data and switches the processing to either for the good environment or for the bad environment. In response to this request, the server 200 executes processing in the bad environment and creates information for recognition. Generation of the information for recognition in the server 200 will be described later.

Next, in step S112, as illustrated in FIG. 11, the information processing device 100 receives the information for recognition transmitted from the server 200. The received information for recognition is supplied from the communication unit 104 to the recognition processing unit 103.

Next, in step S113, the recognition processing unit 103 performs semantic segmentation on the basis of the information for recognition and the infrared ambient light image and the infrared reflected light image, which are the detection results of the LiDAR 30 in the bad environment.

Then, in a case where the traveling of the automobile 20 has ended in step S114, the processing of the information processing device 100 ends (Yes in step S114). In a case where the traveling of the automobile 20 has not ended, the process proceeds to step S108 (No in step S114), and the information processing device 100 repeats steps S108 to S115 until the traveling of the automobile 20 ends.

The description returns to step S109. In step S109, in a case where the information processing device 100 is not connected to the server 200, the process proceeds to step S115 (No in step S109).

Next, in step S115, the recognition processing unit 103 performs semantic segmentation on the basis of the infrared ambient light image and the infrared reflected light image, which are the detection results of the LiDAR 30. In a case where the information processing device 100 and the server 200 are not connected, since the information processing device 100 cannot receive the information for recognition from the server 200, the recognition processing unit 103 performs semantic segmentation using the detection result of the LiDAR 30 even in the bad environment.

Next, processing of the server 200 in a case of the bad environment will be described with reference to FIG. 10B.

First, in step S221, the server 200 acquires the request data, the 3D point cloud information, and the position information transmitted from the information processing device 100. The server 200 refers to metadata indicating whether the environment is good or bad included in the request data and switches the processing so as to execute processing in the bad environment. Note that, in a case where the data transmitted from the information processing device 100 is the 3D point cloud information and the position information and does not include the recognition result, the server 200 may switch the processing so as to execute processing in the bad environment.

Next, in step S222, on the basis of the stored labeled 3D map in the good environment and the 3D point cloud information and position information in the bad environment transmitted from the information processing device 100, the recognition information creation unit 204 estimates the position and orientation of the automobile 20 in the current bad environment with respect to the labeled 3D map in the good environment.

In order to estimate the position and orientation of the automobile 20, a portion of the labeled 3D map in the good environment is first cut out on the basis of the position information. The cut-out range is suitably, for example, a range with a radius of 100 m approximately centered on the position of the automobile 20 indicated by the position information as the observation range in the automobile 20. However, the radius of 100 m is merely an example value, and the cut-out range may be more or less.

The position information detected by a GPS, a compass, or the like as the position information acquisition unit 40 has an error, and the labeled 3D map is large. Therefore, an accurate position of the automobile 20 on the labeled 3D map cannot be specified only by the position information. Therefore, by cutting out a portion of the labeled 3D map on the basis of the position information in this manner, the position of the automobile 20 on the labeled 3D map can be roughly specified, and collation with 3D point cloud information described later can be efficiently performed.

Next, the cut-out labeled 3D map is collated with the position information and the 3D point cloud information. Since the position information acquired by the GPS or the like has an error, the point cloud does not overlap between the 3D shape information and the cut-out labeled 3D map in the original state. Since the cut-out labeled 3D map has a structure having vertex data and label data corresponding to each vertex, the 3D point cloud information and the cut-out labeled 3D map are collated with each other by adjusting the arrangement of the 3D point cloud by using a method of minimizing a distance between point clouds such as iterative closest point (ICP) with respect to the position information, the labeled 3D point cloud, and the cut-out labeled 3D map.

By collating the 3D point cloud information with the cut-out labeled 3D map, it is possible to accurately estimate from which position and from which direction the 3D point cloud has been detected on the labeled 3D map. As a result, it is possible to estimate the position and direction detected by the LiDAR 30 on the labeled 3D map, that is, the detailed position and orientation of the automobile 20 in the current bad environment with respect to the labeled 3D map.

Next, in step S223, the recognition information creation unit 204 creates information for recognition by projecting the labeled 3D map two-dimensionally on the basis of the estimated position and orientation of the automobile 20 and cutting out a 2D label from the labeled 3D map, the 2D label being a two-dimensional image in which a label is added to each pixel.

Then, in step S224, the server 200 transmits the 2D label as the information for recognition to the information processing device 100.

The information processing device 100 receives, in step S112, the information for recognition transmitted from the server 200 in step S224. Then, in step S113, the information processing device 100 performs semantic segmentation on the basis of the information for recognition and the infrared ambient light image and the infrared reflected light image in the bad environment.

The processing in the information processing device 100 and the server 200 is performed as described above. According to the present technology, the information processing device 100 performs recognition processing such as semantic segmentation using the infrared reflected light image and the infrared ambient light image obtained by the LiDAR 30 in the good environment. Then, the server 200 generates and stores a labeled 3D map using the recognition result in the good environment. On the other hand, the information processing device 100 can obtain a highly accurate recognition result even in the bad environment by performing recognition in the bad environment using a 2D label that is information for recognition created by the server 200 from a highly accurate labeled 3D map in the good environment. In the bad environment, the visibility of the infrared ambient light as an input of the recognition processing is reduced, so that the performance of the recognition processing is also expected to be reduced. Therefore, by using the recognition result acquired in the good environment in the past for the recognition processing in the bad environment, the recognition processing such as semantic segmentation can be performed with high accuracy even in the bad environment.

Note that, in the bad environment, the visibility of the infrared ambient light is reduced due to the effect of the environment, but the distance information and the infrared reflected light are less affected by the bad environment than the ambient light. Therefore, in addition to the depth map (distance information) in the bad environment, by using the infrared reflected light image in the bad environment for collation with the labeled 3D map that has been created in the good environment, it is possible to obtain a 2D label as information for recognition necessary for recognition processing in the bad environment.

Furthermore, in order to cut out and create a 2D label as information for recognition from the labeled 3D map, collation with the labeled 3D map is performed using the position information and the 3D point cloud information. As a result, it is possible to improve the positional accuracy of the 2D label cut out from the labeled 3D image.

By improving the accuracy of semantic segmentation, the accuracy of automated driving and driving support of the automobile 20 can be improved. This makes it possible to realize robust automated driving and driving support for various environments.

### Modification

Although the embodiment of the present technology has been specifically described above, the present technology is not limited to the above-described embodiment, and various modifications based on the technical idea of the present technology are possible.

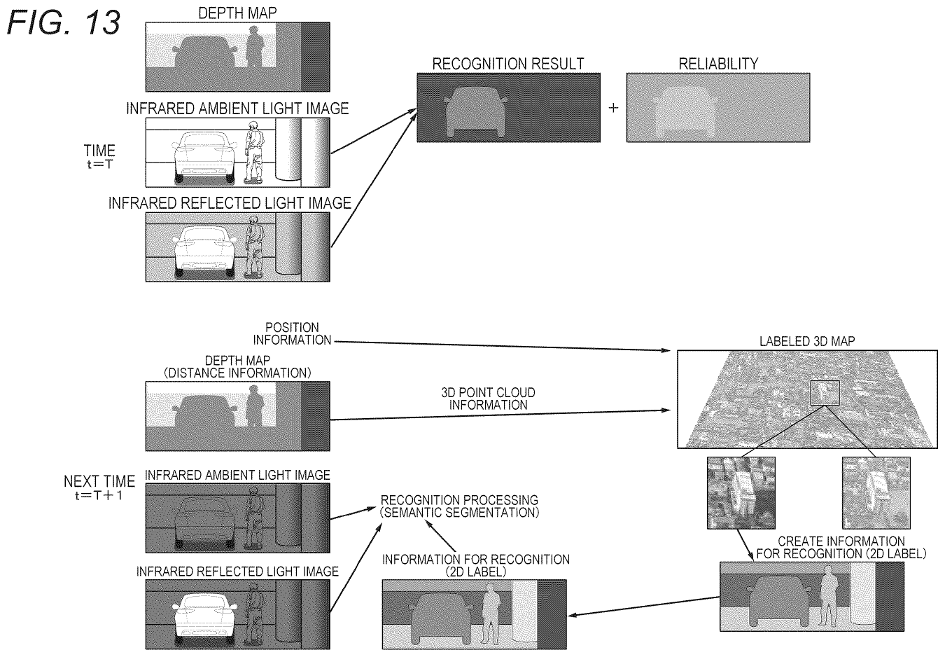

In a case where the recognition processing unit 103 includes an algorithm that outputs a 2D label as a recognition result and also outputs two-dimensional reliability data of the value range from 0 to 1, inclusive, indicating the reliability of each pixel constituting the 2D label, the reliability may be used for determination of the good environment and the bad environment. For example, as illustrated in FIG. 13, in a case where the reliability data is output at the same time as the 2D label of the recognition result by the recognition processing unit 103 at a certain time t=T, and the average of the reliability data of each pixel of the 2D label is less than 0.5, it is determined that the environment is bad. Then, the processing in the next frame at time t=T+1 is switched to processing in an adverse effect, and the recognition processing unit 203 performs the recognition processing using the 2D label as the information for recognition transmitted from the server 200.

Furthermore, the transmission of the position information and the 3D point cloud information from the information processing device 100 to the server 200 and the transmission of the information for recognition from the server 200 to the information processing device 100 are not performed each time, and the labeled 3D map cut out in a large size on the basis of the position information may be transmitted to the information processing device 100 in advance. Then, collation processing between the labeled 3D map and the 3D point cloud information is performed in the information processing device 100. In the case of this method, the communication amount and the communication time required for transmitting the labeled 3D map from the server 200 to the information processing device 100 are large, but the delay until collation between the labeled 3D map and the 3D point cloud information and creation of the 2D label from the labeled 3D map can be reduced.

In the embodiment, the information processing device 100 performs recognition processing using the information for recognition transmitted from the server 200 in the bad environment, but may also perform recognition processing on the basis of the detection result of the LiDAR 30 in the bad environment, and upload the recognition result to the server 200 or aggregate the recognition result as another data set. Although there is a possibility that the accuracy is lower than the recognition result in the good environment, it is possible to easily create a data set of the recognition result in the bad environment as compared with the related art by manually correcting the obtained recognition result, and thus, it is possible to use the data set for raising the recognition performance.

The number of the automobiles 20 having the function as the information processing device 100 is not necessarily one, and may be plural. In a case where there is a plurality of the information processing devices 100, the server 200 may create a labeled 3D map by integrating information in the good environment transmitted from the plurality of information processing devices 100. By using the information transmitted from the plurality of information processing devices 100, it is possible to efficiently create a wide range of labeled 3D maps.

The present technology can be applied not only to the automobile 20 but also to moving bodies such as hybrid electric vehicles, motorcycles, bicycles, personal mobility, airplanes, drones, ships, robots, construction machines, agricultural machines (tractors), and the like. According to the present technology, it is possible to improve the accuracy of automated driving, automated operation, autonomous movement, and the like of these moving bodies. Moreover, the information processing device 100 may operate in an electronic device such as a personal computer, a smartphone, a tablet terminal, or a wearable device.

Furthermore, not only the server 200 but also a personal computer, a tablet terminal, a smartphone, or the like may operate as the second information processing device.

Furthermore, the present technology is not limited to a moving body, and can be applied to any processing such as agriculture, raising and farming of animals and plants as long as the processing uses a result of semantic segmentation.

The present technology can also have the following configurations.

(1)

An information processing device including:
an environment determination unit that determines a state of an environment;
a recognition processing unit that performs recognition processing on the basis of a detection result of a sensor; and
a communication unit that performs communication processing with an external device, in which
in a case where the environment is in a first state, the recognition processing unit performs recognition processing on the basis of the detection result of the sensor, and the communication unit transmits the detection result of the sensor and the recognition result of the recognition processing unit to the external device.
   (2)

The information processing device according to (1), in which in a case where the environment is in a second state, the communication unit transmits the detection result of the sensor to the external device.

(3)

The information processing device according to (1) or (2), in which in a case where the environment is in a second state, the recognition processing unit performs the recognition processing on the basis of information for recognition transmitted from the external device.

(4)

The information processing device according to any one of (1) to (3), in which
the first state is a state in which the recognition processing can be performed with high accuracy on the basis of the detection result of the sensor, and
the second state is a state in which accuracy of the recognition processing is reduced on the basis of the detection result of the sensor.
   (5)

The information processing device according to any one of (1) to (4), in which the environment determination unit determines the state of the environment on the basis of illuminance.

(6)

The information processing device according to any one of (1) to (5), in which the environment determination unit determines the state of the environment on the basis of information regarding weather.

(7)

The information processing device according to any one of (1) to (6), in which the sensor is a single photon avalanche diode (SPAD) LiDAR capable of detecting distance information, infrared reflected light, and infrared ambient light as the detection result.

(8)

The information processing device according to any one of (1) to (7), in which the communication unit transmits, to the external device, position information of a position detected by the sensor, the position information being acquired by a position information acquisition unit.

(9)

The information processing device according to any one of (1) to (8), in which the LiDAR is provided in a moving body.

(10)

The information processing device according to any one of (1) to (9), in which the recognition processing unit performs semantic segmentation.

(11)

An information processing method including:
determining a state of an environment;
performing recognition processing on the basis of a detection result of a sensor; and
performing communication processing with an external device, in which
in a case where the environment is in a first state, the recognition processing is performed on the basis of the detection result of the sensor, and the detection result of the sensor and the recognition result of the recognition processing are transmitted to the external device.
   (12)

A program for causing a computer to execute an information processing method, the method including:
determining a state of an environment;
performing recognition processing on the basis of a detection result of a sensor; and
performing communication processing with an external device, in which
in a case where the environment is in a first state, the recognition processing is performed on the basis of the detection result of the sensor, and the detection result of the sensor and the recognition result of the recognition processing are transmitted to the external device.
   (13)

An information processing device including:
a 3D map creation unit that creates a 3D map on the basis of a detection result and a recognition result of a sensor transmitted from an external device in a case where an environment is in a first state;
a recognition information creation unit that creates information for recognition from the 3D map in a case where the environment is in a second state; and a communication unit that transmits the information for recognition to the external device.
   (14)

The information processing device according to (13), in which the recognition information creation unit creates the information for recognition from the 3D map on the basis of 3D point cloud information that is the detection result of the sensor transmitted from the external device in a case where the environment is in a second state.

(15)

The information processing device according to (13) or (14), in which the recognition information creation unit creates the information for recognition from the 3D map on the basis of position information transmitted from the external device in a case where the environment is in a second state.

(16)

The information processing device according to (15), in which the recognition information creation unit cuts out the 3D map on the basis of the position information and collates the cut-out 3D map with the 3D point cloud information.

(17)

The information processing device according to any one of (13) to (16), in which the 3D map creation unit creates the 3D map on the basis of the recognition result, 3D point cloud information, and position information, the recognition result, the 3D point cloud information, and the position information being transmitted from the external device.

(18)

An information processing method including:
generating a 3D map on the basis of a detection result and a recognition result of a sensor in a case where an environment is in a first state, the detection result and the recognition result being transmitted from an information processing device;
creating information for recognition from the 3D map in a case where the environment is in a second state; and
transmitting the information for recognition to the information processing device.
   (19)

A program for causing a computer to execute an information processing method, the method including:
generating a 3D map on the basis of a detection result and a recognition result of a sensor in a case where an environment is in a first state, the detection result and the recognition result being transmitted from an information processing device;
creating information for recognition from the 3D map in a case where the environment is in a second state; and
transmitting the information for recognition to the information processing device.

### REFERENCE SIGNS LIST

20 Automobile
30 LiDAR
100 Information processing device
101 Environment determination unit
103 Recognition processing unit
104 Communication unit
200 Server
201 Communication unit
202 3D map creation unit
204 Recognition Information Creation Unit

1. An information processing device comprising:
an environment determination unit that determines a state of an environment;
a recognition processing unit that performs recognition processing on a basis of a detection result of a sensor; and
a communication unit that performs communication processing with an external device, wherein
in a case where the environment is in a first state, the recognition processing unit performs recognition processing on a basis of the detection result of the sensor, and the communication unit transmits the detection result of the sensor and the recognition result of the recognition processing unit to the external device.

2. The information processing device according to claim 1, wherein
in a case where the environment is in a second state, the communication unit transmits the detection result of the sensor to the external device.

3. The information processing device according to claim 1, wherein
in a case where the environment is in a second state, the recognition processing unit performs the recognition processing on a basis of information for recognition transmitted from the external device.

4. The information processing device according to claim 1, wherein
the first state is a state in which the recognition processing can be performed with high accuracy on a basis of the detection result of the sensor, and
the second state is a state in which accuracy of the recognition processing is reduced on a basis of the detection result of the sensor.

5. The information processing device according to claim 1, wherein
the environment determination unit determines the state of the environment on a basis of illuminance.

6. The information processing device according to claim 1, wherein
the environment determination unit determines the state of the environment on a basis of information regarding weather.

7. The information processing device according to claim 1, wherein
the sensor is a single photon avalanche diode (SPAD) LiDAR capable of detecting distance information, infrared reflected light, and infrared ambient light as the detection result.

8. The information processing device according to claim 1, wherein
the communication unit transmits, to the external device, position information of a position detected by the sensor, the position information being acquired by a position information acquisition unit.

9. The information processing device according to claim 1, wherein
the LiDAR is provided in a moving body.

10. The information processing device according to claim 1, wherein
the recognition processing unit performs semantic segmentation.

11. An information processing method comprising:
determining a state of an environment;
performing recognition processing on a basis of a detection result of a sensor; and
performing communication processing with an external device, wherein
in a case where the environment is in a first state, the recognition processing is performed on a basis of the detection result of the sensor, and the detection result of the sensor and the recognition result of the recognition processing are transmitted to the external device.

12. A program for causing a computer to execute an information processing method, the method comprising:
determining a state of an environment;
performing recognition processing on a basis of a detection result of a sensor; and
performing communication processing with an external device, wherein
in a case where the environment is in a first state, the recognition processing is performed on a basis of the detection result of the sensor, and the detection result of the sensor and the recognition result of the recognition processing are transmitted to the external device.

13. An information processing device comprising:
a 3D map creation unit that creates a 3D map on a basis of a detection result and a recognition result of a sensor transmitted from an external device in a case where an environment is in a first state;
a recognition information creation unit that creates information for recognition from the 3D map in a case where the environment is in a second state; and
a communication unit that transmits the information for recognition to the external device.

14. The information processing device according to claim 13, wherein
the recognition information creation unit creates the information for recognition from the 3D map on a basis of 3D point cloud information that is the detection result of the sensor transmitted from the external device in a case where the environment is in a second state.

15. The information processing device according to claim 13, wherein
the recognition information creation unit creates the information for recognition from the 3D map on a basis of position information transmitted from the external device in a case where the environment is in a second state.

16. The information processing device according to claim 15, wherein
the recognition information creation unit cuts out the 3D map on a basis of the position information and collates the cut-out 3D map with the 3D point cloud information.

17. The information processing device according to claim 13, wherein
the 3D map creation unit creates the 3D map on a basis of the recognition result, 3D point cloud information, and position information, the recognition result, the 3D point cloud information, and the position information being transmitted from the external device.

18. An information processing method comprising:
generating a 3D map on a basis of a detection result and a recognition result of a sensor in a case where an environment is in a first state, the detection result and the recognition result being transmitted from an information processing device;
creating information for recognition from the 3D map in a case where the environment is in a second state; and
transmitting the information for recognition to the information processing device.

19. A program for causing a computer to execute an information processing method, the method comprising:
generating a 3D map on a basis of a detection result and a recognition result of a sensor in a case where an environment is in a first state, the detection result and the recognition result being transmitted from an information processing device;
creating information for recognition from the 3D map in a case where the environment is in a second state; and
transmitting the information for recognition to the information processing device.
